(19) United States
(12) Patent Application Publication
(10) Pub. No.: US 2022/0375654 A1
(43) Pub. Date: Nov. 24, 2022

(54) TWISTED-PAIR CABLE USING XLPE INSULATION

(71) Applicant: Berk-Tek LLC, New Holland, PA (US)

(72) Inventor: Paul Michael Good, New Holland, PA (US)

(21) Appl. No.: 17/324,650

(22) Filed: May 19, 2021

(51) Int. Cl. H01B 11/02; H01B 3/44; H01B 13/06

(52) U.S. Cl. CPC H01B 11/02; H01B 3/441; H01B 13/06; H01B 3/445

(57) ABSTRACT

Twisted-pair data cables are provided with conductors that are insulated with two or more different materials, where one of the two or more materials is cross-linked polyethylene (XLPE). The use of XLPE in conjunction with other materials within the same cable can ensure that the cable satisfies requirements of heat and flame resistance while reducing the manufacturing cost of such cables.

### TECHNICAL FIELD

The disclosed subject matter relates generally to data cabling.

### BACKGROUND

Many types of data cables, including category-rated cables or other types of networking cables, carry multiple twisted conductor pairs so that multiple data signals can be routed via a single cable. Each conductor is encased within flexible insulative material to prevent electrical shorting between the individual conductors and to protect the conductor from damage. In some types of applications, the materials used to insulate the conductors must satisfy certain safety requirements, including resistance to high heat or flames. The use of insulative materials having the flame-resistant properties necessary to satisfy these safety requirements adds cost to the cable manufacturing process.

The above-described deficiencies of current data cables are merely intended to provide an overview of some of the problems of current technology and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide data cables having conductors that are insulated with two or more different insulative materials, where one of the two or more materials is cross-linked polyethylene (XLPE). The use of XLPE in conjunction with other insulation materials within the same cable can ensure that the cable is sufficiently resistant to heat and flame to satisfy requisite safety requirements while reducing the cost to manufacture such cables.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a cross-sectional view of an example twisted-pair cable containing four twisted pairs of electrical conductors housed within a cable jacket, and which uses two different types of primary insulation for the twisted pairs.

FIG. 2 is a cross-sectional view of an example twisted-pair cable containing four twisted pairs of electrical conductors housed within a cable jacket, in which each conductor is insulated with two layers of insulation.

FIG. 3 is a cross-sectional view of an example twisted-pair cable containing three twisted pairs of electrical conductors housed within a cable jacket, in which each conductor is insulated with three layers of insulation.

FIG. 4 is a cross-sectional view of an example twisted-pair cable containing four twisted pairs of electrical conductors housed within a cable jacket, in which both dual-layered insulation and single-layered insulation are used within the same cable.

FIG. 5 is a flowchart of an example methodology for insulating conductors of a twisted-pair cable.

FIG. 6 is a flowchart of another example methodology for insulating conductors of a twisted-pair cable.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

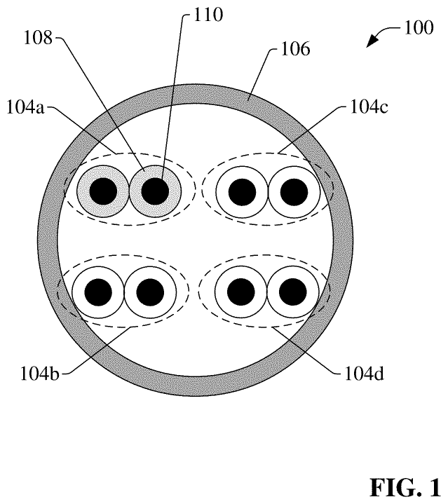

FIG. 1 is a cross-sectional view of an example twisted-pair cable 100 (e.g., a category cable or another type of twisted-pair cable) containing four twisted pairs 104 of electrical conductors 110 housed within a cable jacket 106. Although the example cables depicted herein contain four twisted pairs 104 (labeled 104a-104d in FIG. 1), the insulation approaches described herein can be applied to cables having any number of twisted pairs, or non-twisted conductors. Each twisted pair 104 comprises two conductors 110 that are each encased within a layer of primary insulation 108. For clarity, only one conductor 110 and its associated layer of insulation 108 are labeled in FIG. 1.

Cable 100 is fabricated such that two different types of insulation 108 are used insulate the conductors 110 of the twisted pairs 104, where one of the two types of insulation 108 is cross-linked polyethylene (XLPE) and the other of the two types is another material, such as a flame-retardant polyolefin. The use of XLPE as an insulating material for the conductors 110 of at least one of the twisted pairs 104 can offer advantages relative using polyethylene (PE) or another material as the sole type of insulation used to protect the conductors 110. For example, XLPE has a high tensile strength, and is less likely to elongate or deform at high temperatures relative to some other insulative materials. XLPE also has a high resistance to abrasion, which makes XLPE suitable for use in high heat environments as well as in application in which the cable 100 will be flexed such as certain types of industrial installations. XLPE is also less expensive than many other heat-resistant materials often used to insulate twisted conductor pairs.

In the example depicted in FIG. 1, the conductors 110 of one of the twisted pairs 104a are encased in a layer of insulation 108 made of XLPE (depicted in grey), while the conductors 110 of the other twisted pairs 104b-104d are housed in layers of insulation 108 made of another insulative material (depicted in white), such as solid fluorinated ethylene propylene (FEP), foamed FEP, striated FEP, flame-retardant polyolefin, or another material. Although FIG. 1 depicts an embodiment in which only one out of four twisted pairs 104 is insulated using XLPE, while the other three twisted pairs 104 are insulated with a different material, any number of twisted pairs 104 less than the total number of twisted pairs 104 available in the cable 100 can be insulated using XLPE. In general, any cable comprising two or more twisted pairs 104 in which at least one of the twisted pairs 104 is insulated using XLPE, and at least one other of the twisted pairs 104 is insulated using another type of insulating material, is within the scope of one or more embodiments of this disclosure.

Since the cost of XLPE is typically less than that of many other types of insulation (e.g., FEP), insulating one or more of the available twisted pairs 104 within a cable 100 using XLPE, while using a different material for one or more other available twisted pairs 104, can achieve a balance between performance and cost of the resulting cable 100. For example, although insulating the conductors 110 of all available twisted pairs 104a-104d using FEP will allow the resulting cable 100 to pass heat-related safety tests (e.g., plenum or flame tests), the cable 100 can be manufactured at lower cost while still passing these safety tests if FEP is replaced with XLPE on one or more of the available twisted pairs 104 as the material properties of XLPE render this material resistant to deformation or damage in high temperature environments.

In the example illustrated in FIG. 1, the twisted pairs 104b-104d that are not insulated with XLPE are insulated using the same material, such that a total of two different insulation materials (XLPE and a second material) are used to insulate the twisted pairs 104. However, in some embodiments, more than two different materials can be used to insulate the conductors 110 of the twisted pairs 104 within the same cable. For example, one or more of the twisted pairs 104 can be insulated using XLPE, a first subset of the remaining twisted pairs 104 can be insulated with a second material, and a second subset of the remaining twisted pairs 104 can be insulated with a third material. The second and third materials can be any suitable insulation material, including but not limited to solid FEP, foamed FEP, striated FEP, flame-retardant polyolefin, or other such materials. Any number of different primary insulation materials for the twisted pairs 104 can be used within a single cable 100 without departing from the scope of one or more embodiments of this disclosure.

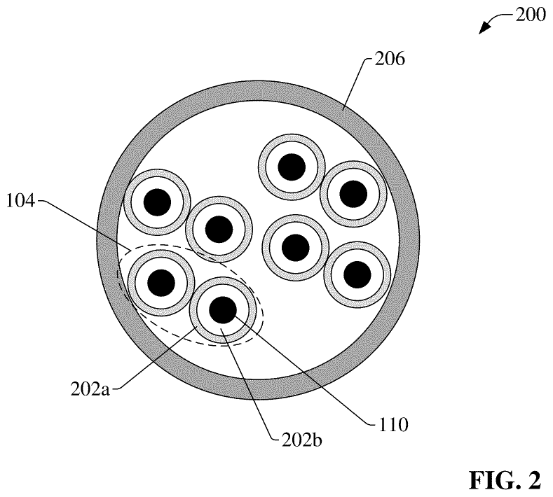

The example illustrated in FIG. 1 depicts a cable design in which each conductor 110 is insulated using a single layer of insulation that is either XLPE or another material. In some embodiments, XLPE and one or more other insulation materials can be used within the same cable by layering the different insulation materials on each conductor 110. FIG. 2 is a cross-sectional view of an example twisted-pair cable 200 (e.g., a category cable or another type of twisted-pair cable) containing four twisted pairs 104 of electrical conductors 110 housed within a cable jacket 206, in which each conductor 110 is insulated with two layers 202a and 202b of insulation, one layer 202a being XLPE and the other layer 202b being another insulation material (e.g., any of the other materials noted above). The use of XLPE as one of two (or more) different insulation materials layered on each conductor 110 can reduce costs associated with manufacturing the cable 200 while ensuring that the cable 200 satisfies safety requirements and passes requisite heat or flame tests.

The example illustrated in FIG. 2 depicts the XLPE layer as the outer layer 202a, while another material—e.g., FEP—is used for the inner layer 202b. Since the inner layer 202b is in contact with the conductor 110, it may be advantageous to use the insulation material having the lower dielectric constant as the inner layer 202b. For example, if XLPE and FEP are used as the two insulation materials, FEP may be used as the inner layer 202b while XLPE is used as the outer layer, since FEP has a lower dielectric constant than XLPE. In general, the quality of a signal conveyed by a conductor 110 is impacted by the insulative material closest to the conductor 110. Using a material having a lower dielectric constant for the insulation layer that is in direct contact with the conductor 110 results in less signal loss and a higher velocity of signal propagation relative to using a material with a higher dielectric constant. The dielectric constant of the insulation closest to the conductor 110 also factors into the attenuation parameter which, together with the velocity of signal propagation, affects delay and delay skew parameters.

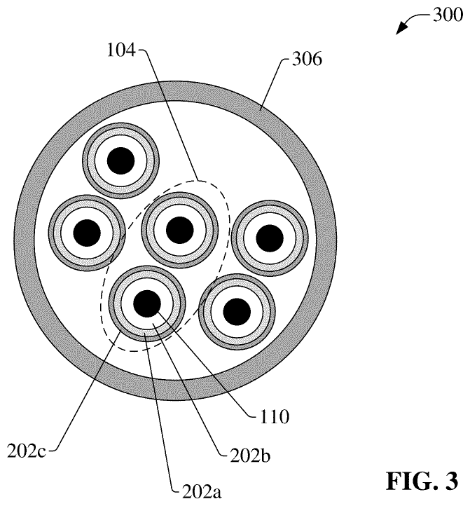

Although FIG. 2 depicts an embodiment in which only two layers of insulation are applied to each conductor 110, some embodiments may apply more than two layers of insulation to each conductor 110, where one of the layers comprises XLPE. FIG. 3 is a cross-sectional view of an example twisted pair cable 300 containing three twisted pairs 104 housed within a cable jacket 306, in which each conductor 110 is insulated with three layers 202a, 202b, 202c of insulation, with one layer 202a being XLPE and the other layers 202b, 202c being another insulation material (e.g., any of the other materials noted above).

Also, while FIG. 2 depicts the same insulation layering configuration being used for each conductor 110, some embodiments may use two or more different layering configurations for different conductors 110. For example, a first subset of the available conductors 110 may be layered with XLPE and a first non-XLPE insulation material, while a second subset of the conductors 110 may be layered with XLPE and a second non-XLPE insulation material.

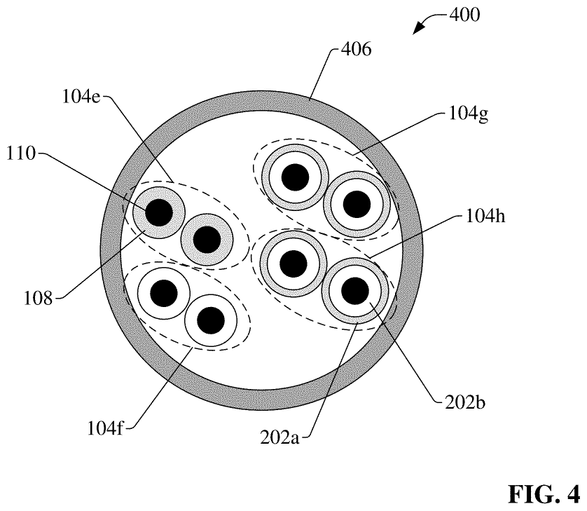

In some embodiments, the approaches depicted in FIGS. 1 and 2 can be combined within the same cable. FIG. 4 is a cross-sectional view of an example twisted-pair cable 400 (e.g., a category cable or another type of twisted-pair cable) containing four twisted pairs 104 of electrical conductors 110 housed within a cable jacket 406, in which both dual-layered insulation (as illustrated in FIG. 2) and single-layered insulation (as illustrated in FIG. 1) are used within the same cable. As in the examples discussed above, at least two different insulation materials are used within the cable 400, and one of the at least two insulation materials is XLPE.

In this example, two of the twisted pairs 104e and 104f each have a single layer of insulation 108 on their conductors 110, with XLPE used as the insulation for one of the single-layered twisted pairs 104e and another material (e.g., solid FEP, foamed FEP, strained FEP, flame-retardant polyolefin, or another material) used as the insulation for the other single-layered twisted pair 104f. The remaining two twisted pairs 104g and 104h each have two layers 102a and 102b of insulation on each of their conductors 110, with one layer 202a comprising XLPE and the other layer 202b comprising another material.

Although FIG. 4 depicts only two materials—XLPE and another material—being used as primary insulation within cable 400, more than two different materials can be used in any combination within cable 400 without departing from the scope of one or more embodiments. For example, if cable 400 houses more than two single-layered twisted pairs 104e, 104f, then more than two different materials can be used as the layer of insulation 108 across the single-layered twisted pairs 104. Similarly, the non-XLPE layer 202b of the dual-layered twisted pairs 104g, 104h may comprise more than two different materials, with the pairs 104g, 104h using a different material. Moreover, the dual-layered twisted pairs 104g, 104h may be replaced with twisted pairs having more than two layers of insulation, where one of the layers comprises XLPE and the other layers comprise two or more other insulation materials.

Also, while FIG. 4 depicts a design in which each twisted pair 104 comprises either two conductors 110 that each have a single layer of insulation 108 (e.g., twisted pairs 104e and 104f) or two conductors that each have multiple layers 202 of insulation (e.g., twisted pairs 104g and 104h), some embodiments may comprise twisted pairs 104 that each comprise a first conductor 110 having a single layer of insulation 108 and a second conductor having multiple layers 202 of insulation. In such embodiments, XLPE can be used for any of the layers on any of the conductors, in conjunction with one or more other insulation materials used for other layers.

Using XLPE as one of two or more different primary insulation materials within the same cable, as described above, can yield a cable that is sufficiently durable and heat-resistant to pass requisite safety tests, and is suitable for use in high-heat environments, while also reducing manufacturing costs relative to cables that exclusively use non-XLPE materials as primary insulation.

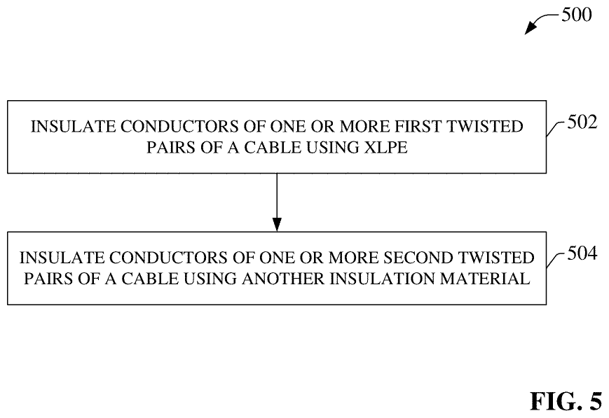

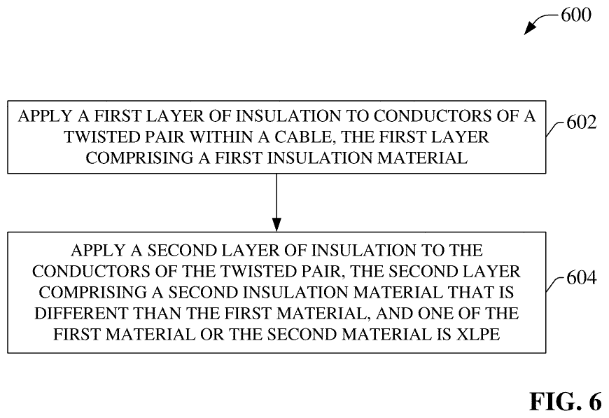

FIGS. 5-6 illustrate various methodologies in accordance with one or more embodiments of the subject application. While, for purposes of simplicity of explanation, the methodologies shown herein are described as a series of steps, it is to be understood and appreciated that the subject innovation is not limited by the order of steps, as some steps may, in accordance therewith, occur in a different order and/or concurrently with other steps from that shown and described herein. For example, those skilled in the art will understand and appreciate that a methodology could alternatively be represented as a series of interrelated states or events, such as in a state diagram. Moreover, not all illustrated steps may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 5 illustrates an example methodology 500 for insulating conductors of a twisted-pair cable. Initially, at 502, conductors of one or more first twisted pairs of a cable are insulated using XLPE. At 504, conductors of one or more second twisted pairs of a cable are insulated using another insulation material. In various embodiments, the other insulation can be solid FEP, foamed FEP, striated FEP, flame-retardant polyolefin, or another such material. In some embodiments, if there are additional twisted pairs housed in the cable that are not included in the first and second twisted pairs, these additional twisted pairs can be insulated using still another insulation material.

FIG. 6 illustrates an example methodology 600 for insulating conductors of a twisted-pair cable. Initially, at 602, a first layer of insulation is applied to conductors of a twisted pair within the cable, the first layer comprising a first insulation material. At 604, a second layer of insulation is applied to the conductors of the twisted pair, the second layer comprising a second insulation material that is different than the first material. One of the first material or the second material is XLPE.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A data cable, comprising:
twisted pairs of electrical conductors housed inside a jacket,
wherein
at least a first material and a second material are used to insulate the electrical conductors, and
the first material is cross-linked polyethylene.

2. The data cable of claim 1, wherein the second material is at least one of solid fluorinated ethylene propylene (FEP), foamed FEP, striated FEP, or polyolefin.

3. The data cable of claim 1, wherein
a first conductor of the electrical conductors comprises a single insulation layer comprising the first material, and
a second conductor of the electrical conductors comprises a single insulation layer comprising the second material.

4. The data cable of claim 1, wherein
a first subset of the twisted pairs comprise a first subset of the electrical conductors insulated with the first material, and
a second subset of the twisted pairs comprises a second subset of the electrical conductors insulated with the second material.

5. The data cable of claim 1, wherein
at least one conductor of the electrical conductors comprises at least two layers of insulation,
a first layer of the at least two layers comprises the first material, and
a second layer of the at least two layers comprises the second material.

6. The data cable of claim 5, wherein the first layer is an outer layer of the at least two layers.

7. The data cable of claim 5, wherein
at least another conductor of the electrical conductors comprises a single layer of insulation, and
the single layer of insulation comprises one of the first material or the second material.

8. The data cable of claim 1, wherein the data cable is a category cable.

9. A cable, comprising:
a jacket; and
twisted conductor pairs housed inside the jacket,
wherein
conductors of the twisted conductor pairs are insulated using at least two different insulation materials, and
a material of the at least two different insulation materials is cross-linked polyethylene.

10. The cable of claim 9, wherein another material of the at least two different insulation materials is at least one of solid fluorinated ethylene propylene (FEP), foamed FEP, striated FEP, or polyolefin.

11. The cable of claim 9, wherein
a first conductor of the twisted conductor pairs comprises a single layer of insulation comprising cross-linked polyethylene, and
a second conductor of the twisted conductor pairs comprises a single layer of insulation comprising another material of the at least two different insulation materials.

12. The cable of claim 9, wherein
a first subset of the twisted conductor pairs comprises a first subset of the conductors insulated with cross-linked polyethylene, and
a second subset of the twisted conductor pairs comprise a second subset of the conductors insulated with another material of the at least two different insulation materials.

13. The cable of claim 9, wherein
at least one conductor of the conductors comprises two or more layers of insulation,
a first layer of the two or more layers comprises cross-linked polyethylene, and
a second layer of the two or more layers comprises another material of the at least two different insulation materials.

14. The cable of claim 13, wherein the first layer is an outer layer of the two or more layers.

15. The cable of claim 13, wherein at least another conductor of the conductors comprises a single layer of insulation comprising one of the at least two different insulation materials.

16. The cable of claim 9, wherein the cable is a category cable.

17. A method for fabricating a cable, comprising:
insulating a first subset of electrical conductors using cross-linked polyethylene;
insulating a second subset of the electrical conductors using another insulation material;
twisting pairs of the electrical conductors together to yield twisted pairs; and
housing the twisted pairs in a cable jacket.

18. The method of claim 17, wherein the insulating of the second subset of the electrical conductors comprises insulating the second subset using at least one of solid fluorinated ethylene propylene (FEP), foamed FEP, striated FEP, or polyolefin.

19. The method of claim 17, wherein
the insulating of the first subset of the electrical conductors comprises insulating the first subset with at least two layers of insulation,
a first layer of the at least two layers comprises cross-linked polyethylene, and
a second layer of the at least two layers comprises the other insulation material.

20. The method of claim 17, wherein the twisting yields a first subset of the twisted pairs comprising the first subset of the electrical conductors and a second subset of the twisted pairs comprising the second subset of the electrical conductors.
